(19) United States
(12) Patent Application Publication
(10) Pub. No.: US 2007/0066404 A1
(43) Pub. Date: Mar. 22, 2007

(54) Interactive DVD multi player board game

(75) Inventors: Ronald Leong, Westport, CT (US); Peter Adams, Green Valley, CA (US); William Hindorff, San Jose, CA (US)

Correspondence Address: WILLIAM J. SAPONE;COLEMAN SUDOL SAPONE P.C., 714 COLORADO AVENUE, BRIDGE PORT, CT, 06605, US

(73) Assignee: iGameworks, Inc., Westport, CT (US)

(21) Appl. No.: 11/385,435

(22) Filed: Mar. 21, 2006

Related U.S. Application Data
(60) Provisional application No. 60/718,183, filed on Sep. 16, 2005.
(60) Provisional application No. 60/739,310, filed on Nov. 23, 2005.

(51) Int. Cl. A63F 13/00

(52) U.S. Cl. 463/43

(57) ABSTRACT

An interactive multi player DVD gaming system comprising a DVD containing game data and a game manager program for playing an interactive DVD board game on a display, and a DVD media player configured for accessing and displaying the game data on the DVD in response to receiving user selected inputs. At least one user operated control is provided for generating the user selected inputs sent to the DVD media player. The DVD media player has multiple general parameter register memories (GPRM's), the game program manager configured to direct the GPRM's for supporting multiplayer game play with display of a virtual game board.

### CROSS-REFERENCE TO RELATED APPLICATIONS

This application claims priority in U.S. Provisional patent application Nos. 60/718,183 filed Sep. 16, 2005 and 60/739,310 filed Nov. 23, 2005.

### TECHNICAL FIELD

This invention relates to DVDs and more particularly to DVDs which provide interactive multiplayer game play with non-numeric visual scoring.

### BACKGROUND

A DVD is a high capacity optical disk formatted for storage and retrieval typically of multimedia content. Usually, a DVD contains one or more digitally recorded works, such as movies or music, or may contain computer data. There are known technologies for recording video, audio, data, etc onto a DVD. The DVD is typically played on a dedicated DVD player or a related playing device of limited processing capacity, which may be portable or stationary, though such disks can also be used with a desktop or laptop computer. However, even when used on a computer, the application software for running the DVD typically limits the processing capability to those functions commonly found for example with a portable DVD player or video tape player.

Usually, DVDs are read by devices that provide features such as fast forward, rewind, pause, frame by frame advance, etc., which are options usually associated with the display of recorded audio, video programs such as movies, music, videos, TV programs, etc. Often the recorded media is broken down into defined blocks of data, usually referred to as “chapters” for skipping to particular sequences of interest to the user.

Generally, a DVD is a convenient medium for storage and retrieval of such information.

In U.S. published application no 2003/0199292, a DVD which includes a game is discussed. While DVD's are commonly used to store game data when used with gaming application software played on a computer having significant processing capability, they are not generally know for game play on the typical much lower cost media player used to display movies or music videos.

In the '292 patent application, various instant win frames are discussed. A user watches a video sequence, with game play initiated in a question and answer format and a prize awarded based on a winning selection. The prize is the unlocking of a video sequence of interest to the user which is then displayed. This disclosure is limited to single user game play.

In U.S. published application no 2005/075166, a method for playing an interactive game using a DVD player is discussed. A user can input signals which cause play in selected segments. In essence, a media program is configured to produce an audio-visual stream that provides an interactive feature similar to a feature found on typical video games played on dedicated game consoles. Such consoles have much more processing capability that a typical DVD player, similar to computer application driven video games. In the '166 patent application, as an animated element moves over a predetermined background, the animated element appears to enter and exit different regions with the user guiding the animated element over these regions so as to appear, for example, as if the user is driving over a particular background. Arrow keys or a joystick are used to guide the animated element during game play. Interactive multi-user play is not contemplated.

In U.S. Patent application publication no 2005/0014563, an interactive DVD gaming system is discussed. A DVD player uses the limited available memory bits of the DVD to provide an improved “game feel” to the DVD game when played on a conventional DVD player, closer to the game feel of a computer based or game console system game. However, even with the special programming using the limited available memory, game play is still limited in its capabilities and in particular, moves in step wise fashion, using a numeric scoring system.

One of the inherent problems in using a media player to deliver and manage game play is that there is no significant processing capability contained in a media player, such as a DVD player, in the form of for example, a microprocessor. Therefore, all information intended to be displayed must be prerecorded and available for selection, rather than having results dynamically calculated, or results graphically created and displayed as in the scoring in a video game or computer game. Although numerical scoring can be shown, games in which player positioning represents progress from a starting point to a finish point on a game board with spaces has not been achieved. Since all results in a media player must be prerecorded, in order to have a game board with for example, 16 landing spaces in a multiplayer game with 4 players, the database for the game must have available all the possible player combinations showing the player positions on a game board that would require 65,536 separate videos. This would take up a substantial amount of valuable disk memory that would be unavailable for game play, questions and videos and require a complicated system of video retrieval sequencing to execute and show each player's move on the board.

### SUMMARY OF THE INVENTION

Generally it is an object of the present invention to overcome these problems and provide improved game feel and facilitate game play of a DVD game played by multiple players using a conventional DVD player having limited processing capability.

In particular, it is an object of the invention to provide a virtual board game that can be played by multiple players on a conventional DVD player, which provides continual visual feedback as to progress in the game, to correspond to the game feel of a real board game.

Yet another object is to provide an improved DVD game that utilizes an interactive segmented game board display with the segmented regions defining positional information of one player relative to another, continuously, which provides visual feedback of the progress of the players as they move through the game playing sequence.

It is another object to provide a DVD game that utilizes an interactive segmented game board display with the segmented regions generating displays, movement and/or other information for initiating feedback from a player, the generation related to random access to data segments contained on the DVD, such as a text question, video clip, jump to another segment, announcement (i.e. “Lose Turn”), etc., such that a player virtually landing on a particular segment triggers an action.

These and other objects of the present invention are achieved by an interactive multiplayer DVD gaming system comprising a DVD containing game data and program instructions, a DVD player configured for accessing and displaying the game data on the DVD in response to receiving user selected inputs, at least one user operated control for issuing instructions to the DVD player, the DVD player having multiple general parameter register memories (GPRM), the program instructions configured to direct the GPRM for supporting multiplayer game play with display of a virtual game board.

### BRIEF DESCRIPTION OF THE DRAWINGS

FIG. 1 is an overview illustrating the use of the inventive DVD for multiplayer game play.

FIG. 2 is a flow chart of the method for controlling a DVD board game playable on a DVD player.

FIG. 3 is a flow chart illustrating a configuration that simulates a single dice rolling function as configured for use with a DVD player.

FIG. 4 is a flow chart illustrating a configuration that simulates a two dice roll as configured for use with a DVD player.

FIG. 5 is a flow chart illustrating a configuration that simulates a wheel spin as configured for use with a DVD player.

FIG. 6 is an illustrative view of a display of a game board, as it would appear on a screen.

FIG. 7 is an illustrative view showing the position of player 1 on the displayed game board of FIG. 6.

FIG. 8 is an illustrative view showing the position of player 2 on the displayed game board of FIG. 6.

FIG. 9 is an illustrative view showing the position of player 3 on the displayed game board of FIG. 6.

FIG. 10 is an illustrative view showing the position of player 4 on the displayed game board of FIG. 6.

FIG. 11 is an alternative game board embodiment that could be displayed.

FIG. 12 is an illustrative view showing the position of player 1 on the displayed game board of FIG. 11.

FIG. 13 is an alternative game board embodiment that could be displayed.

FIG. 14 is an illustrative view showing the position of player 1 on the displayed game board of FIG. 13.

FIG. 15 is an alternative game board embodiment that could be displayed.

FIG. 16 is an illustrative view showing the position of player 1 on the displayed game board of FIG. 15.

FIG. 17 is an alternative game board embodiment, using text as the board segments that could be displayed.

FIG. 18 is an illustrative view showing the position of player 1 on the displayed game board of FIG. 17.

### DETAILED DESCRIPTION OF THE INVENTION

The present invention utilizes a DVD configured to provide a game board on a display screen with an indication of player position, to allow tracking the progress of multiple players, one player at a time, on the displayed game board. Utilizing such a game board, requires, for example, with four players, only 64 different combinations of game board displays, 16 for each of the 4 players on a game board with 16 landing spaces, and at the same time, provides a method for each player to know where they are relative to other players.

With a typical physical board game (non-electronic media), all the players have game movers or pieces that are visible simultaneously on the board to show relative progress and who is winning or losing in a game. To simulate a similar experience when using only a DVD based game loaded in a DVD player, and overcome this visual problem in a DVD displayed game, a media game board for the DVD game is provided which gives a distinct visual frame of reference so that each player can use a relative “spatial relationship” to some object or position on the screen or some other reference point to know where they are relative to other players without the need to see all the players simultaneously or remember a numerical score. Therefore, when players are shown their individual position on a game board, they can use the relative position to the “object” to determine where they are relative to the position of other players on the game board. Hence, they can determine who is winning and who is losing without memorizing the individual player boards and positions.

The best example to illustrate this is to note a car race where four (4) cars, red, green, blue and black, are within one car length of each other with the red car in the lead. If all cars are shown in the same picture, it is obvious that the red car is ahead. If each car is shown individually, one would not know which car is in the lead or where each car is positioned relative to the other. However, if a light pole were shown on the track and the red car was positioned to the right of the pole and the other 3 cars were individually shown to be to the left of the pole, it would be obvious to determine that the red car was in the lead.

The invention provides an interactive multi player DVD gaming system comprising a DVD containing game data and a game manager program, a DVD player configured for accessing and displaying the game data on the DVD in response to receiving user selected inputs, at least one user operated control for issuing instructions to the DVD player, the DVD player having multiple general parameter register memories (GPRM), the program instructions configured to direct the GPRM to support multiplayer game play and to display of a virtual game board.

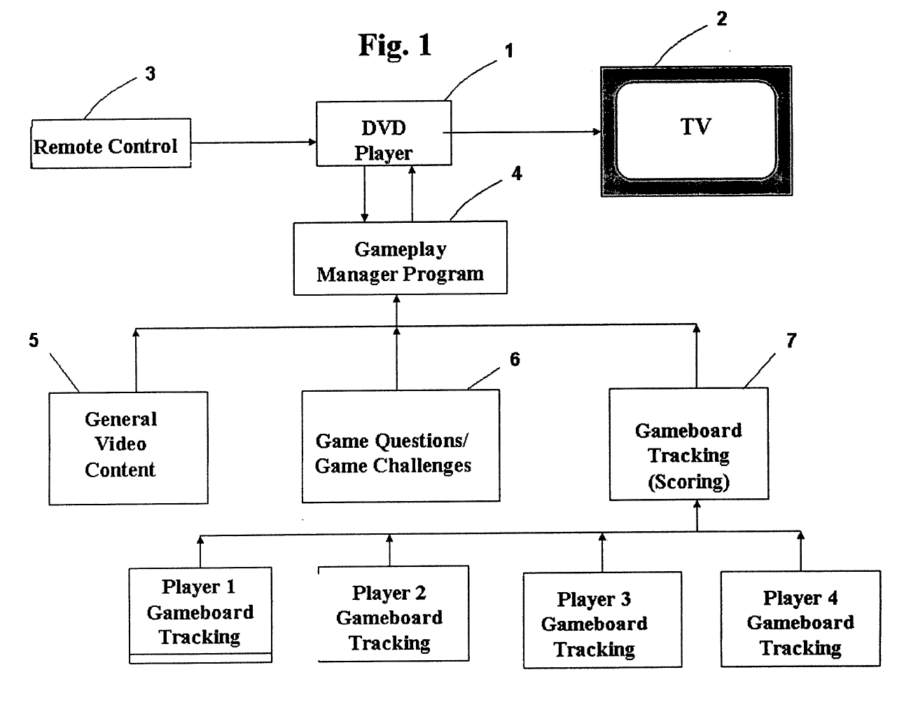

Referring to FIG. 1, a DVD player 1 is connected to a TV monitor 2 which represents the typical monitor used with such a player. Of course, any type or size of monitor used with DVD players may be used with the present invention. A remote control 3 controls the DVD player, having the usual function buttons, with control commands such as “Play,” “Pause,” “Stop,” “Fast Forward,” “Rewind,” “Menu,” “Enter,” etc. While a typical DVD remote control may be used with the function keys defined for game play to the user, such as “enter” meaning for example “roll dice”, a custom controller having specific game functions and programmable for use with various DVD players could also be used and included, for example, in a game package.

A DVD which is loaded into the DVD player has a game manager program 4, to support multiplayer gaming as well as stored game information, such as general video content 5, game questions/game challenges 6 and game board tracking 7, which equates a score with a position of the player on a displayed game board. As illustrated, with a four player game, the game board tracking has stored information for display of every position the player can assume during game play, as controlled for display by the game play program manager.

In particular, the DVD has data readable by the DVD player for display of a designated region on a monitor, which may be a presented as a border, separated into discrete segments simulating a typical game board where a player moves from space to space in response usually to a random number generated for example by a roll of dice, a wheel spin etc. The DVD can be programmed to provide random number capability sufficient to simulate such actions, which can be visually displayed to the player as a movie clip of a roll of dice or a wheel spin, with the proper audio to add authenticity.

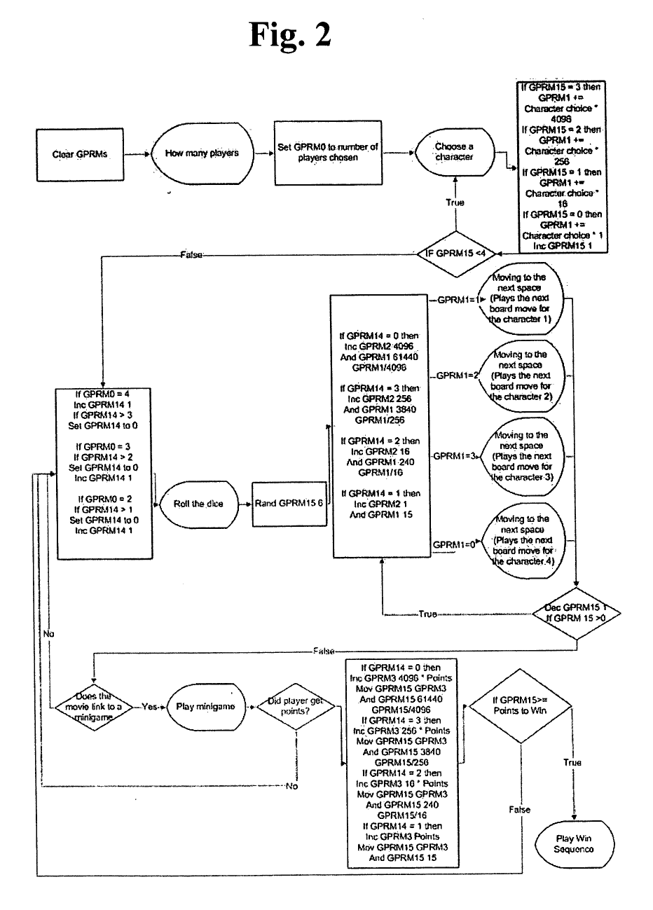

Referring to FIG. 2, the method for playing a DVD based multiplayer board game is illustrated in a flow diagram with reference to the GPRM's accessible on the DVD player, as controlled by the game play manager program on the DVD media. When activated, the game manager program first clears the GPRM's, and then receives input on the number of users. This illustration shows a system where up to four players can play the game, though the invention is not so limited.

In FIG. 2, the following notes apply:

GPRM 0=Total number of players;

GPRM 1=Players' character index;

GPRM 2=Players' current board position;

GPRM 3=Players' current point score;

GPRM 4 thru 13 are expansions for various game play logic;

GPRPM 14=which players' turn it is; and,

GPRM 15=Temporary variable (case 1 is which player is choosing a character index, case 2 is the current dice roll, case 3 is a score placeholder)

The game program manager then sets the GPRM's accordingly, and obtains input from each player as to their choice of game piece, here represented as a character, though this could be any of a number of symbols, such as a car.

Once each player chooses their character, the game play begins, with a random number generator program, such as a dice roll. The roll of the dice is displayed for example as a film clip, selected from the data stored on the DVD, and then, the game program manager displays a clip showing the designated character moving the generated number of spaces on the game board. Landing on a particular space then can cause one of several options. This could include an automatic lose turn, move forward or backward a certain number of spaces, or activate a mini-game, that is, a question for example, that requires the user to input an answer, such as a choice question where the user selects A, B, C, or D. Depending on the players' answer, the player can accumulate or lose points, or move forward or backward on the game board. No player wins the game until they have properly moved to the win position and/or accumulated sufficient points to win

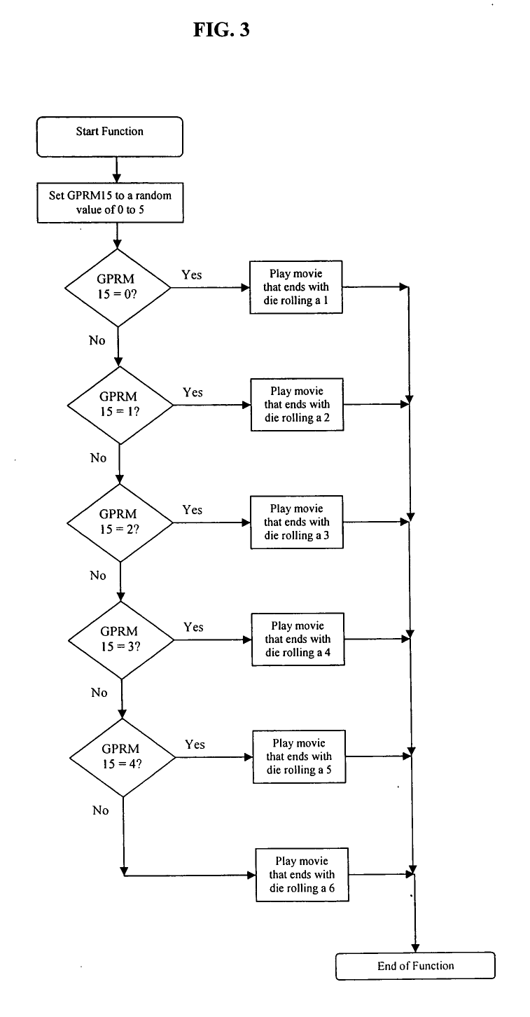

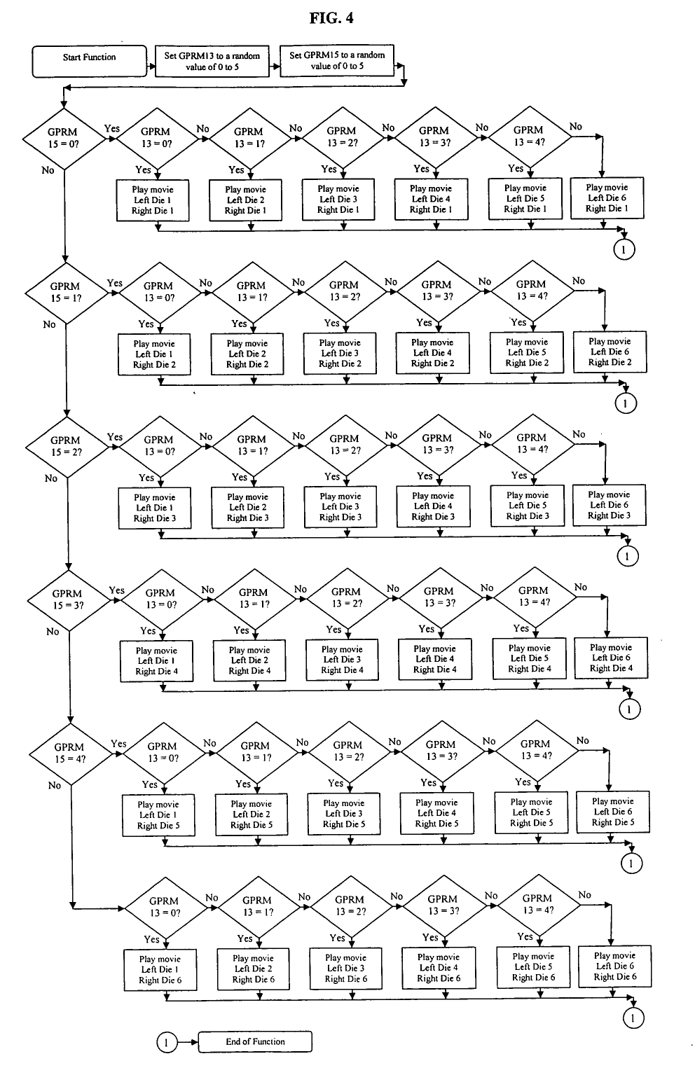

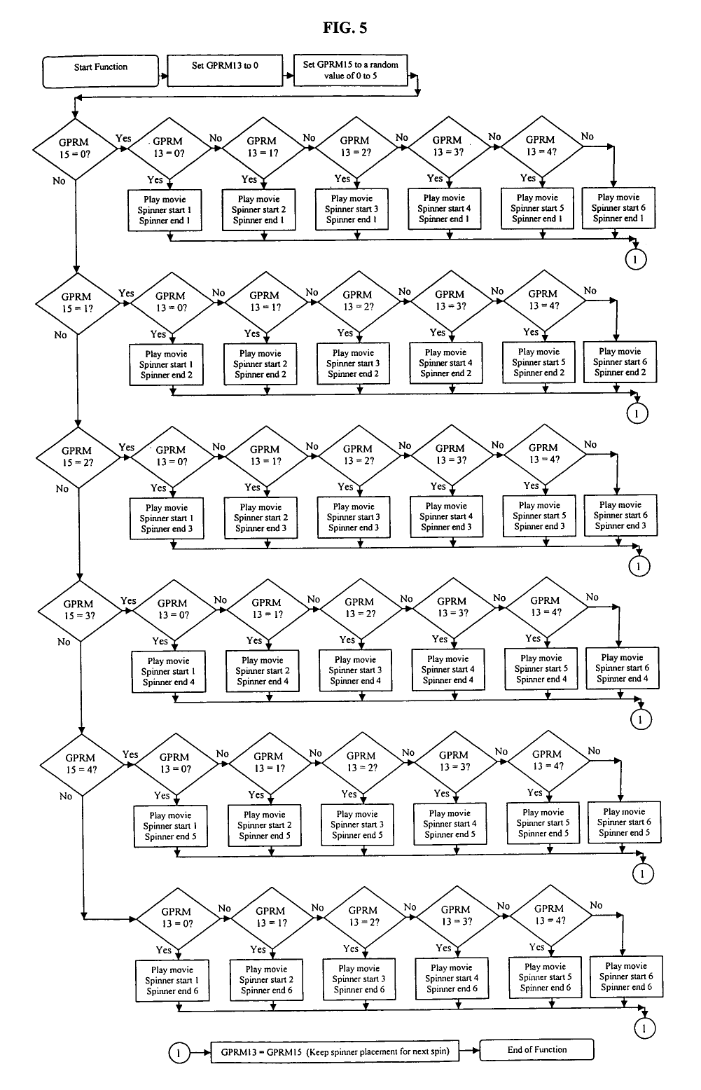

The DVD programming may be configured to provide a single dice rolling function, a two dice rolling function, or a spinner type function, as illustrated in the enclosed FIGS. 3, 4 and 5. In the case, for example, of a single dice roll, illustrated in FIG. 3, a GPRM is set to a random value from 0 to 5, corresponding to the dice sides which number from 1 to 6. With the increase in values of a two dice roll (FIG. 4) or a spinner (FIG. 5), two GPRM's are used, each set to a random value of from 0 to 5, and the results of the various random number generations are used to, for example, play a video clip showing the dice or spinner displaying the random number generated. Of course, variations can be made so as to tailor the number of random combinations to a specific game, and the invention is not limited to these particular embodiments.

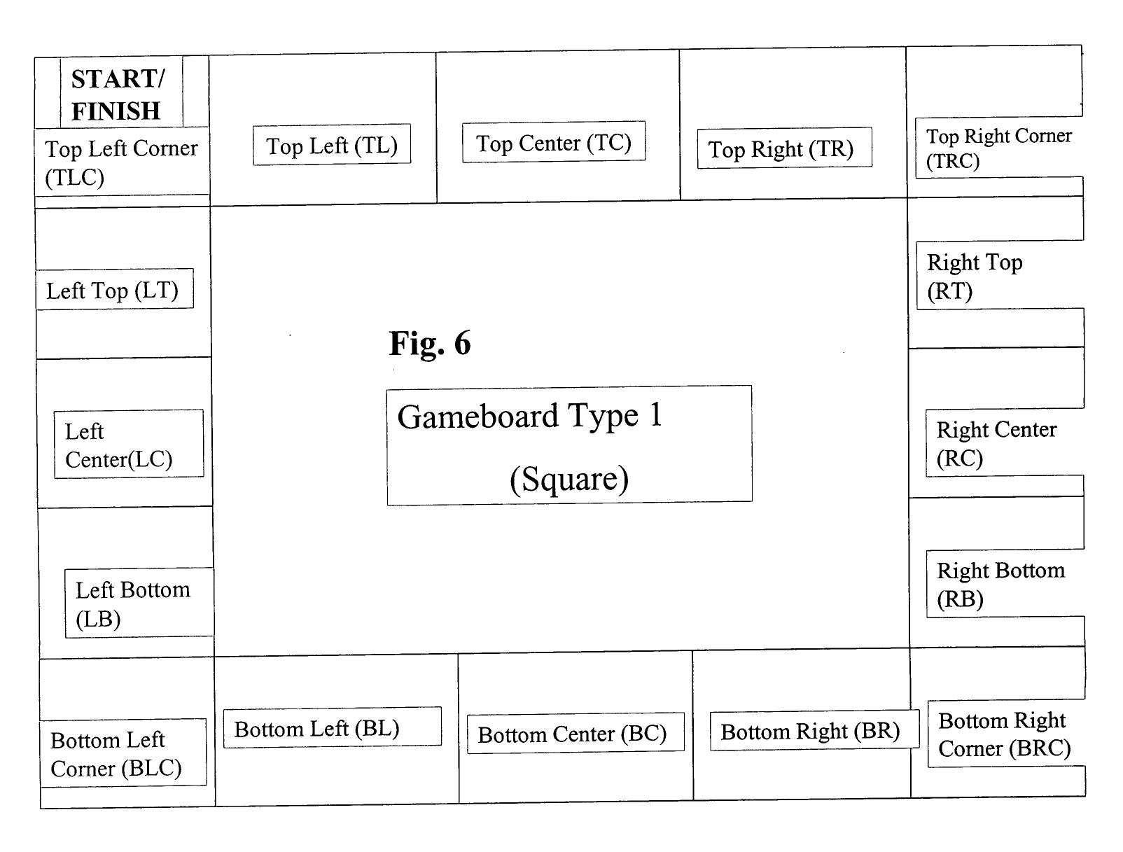

Referring to FIG. 6, an exemplary game board 4 is shown which would be displayed on a monitor screen. This game board has a start/finish position, shown as a top left corner segment, with the center open area used for viewing the various clips responsive to player input such as dice rolls, or for displays of questions, answers, messages (“You Lose!”, “Try Again”, etc.)

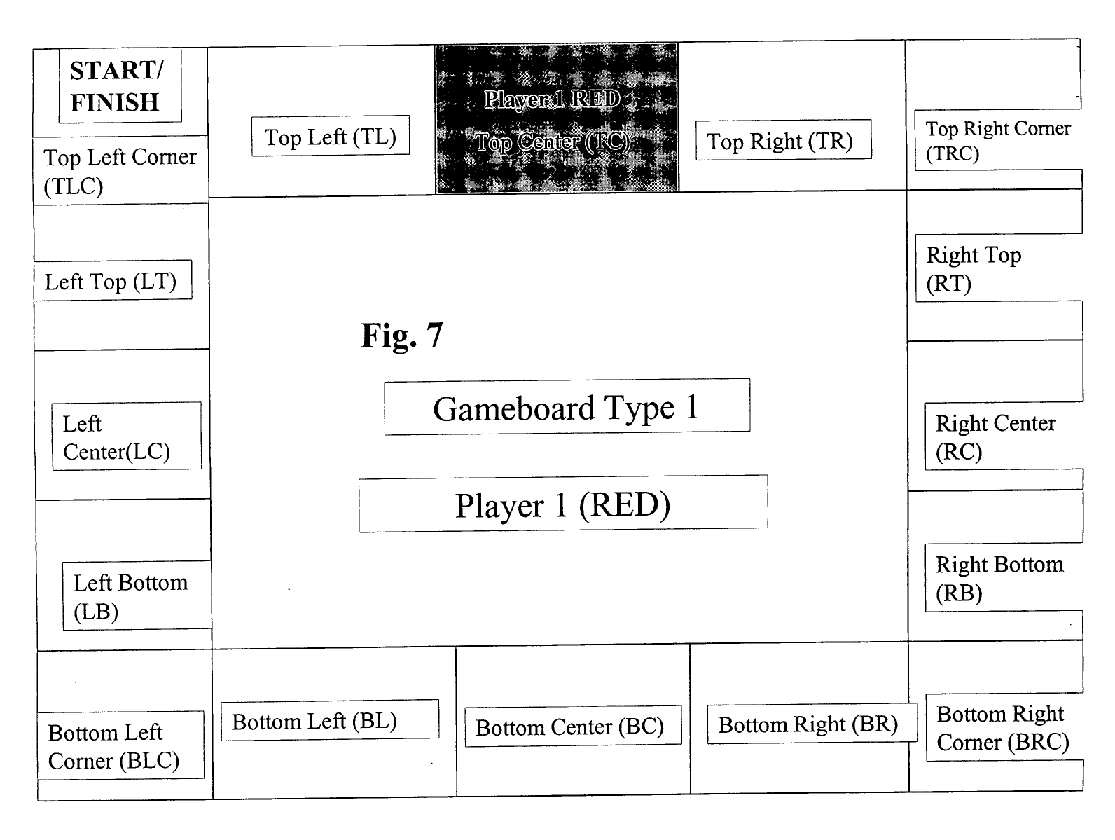

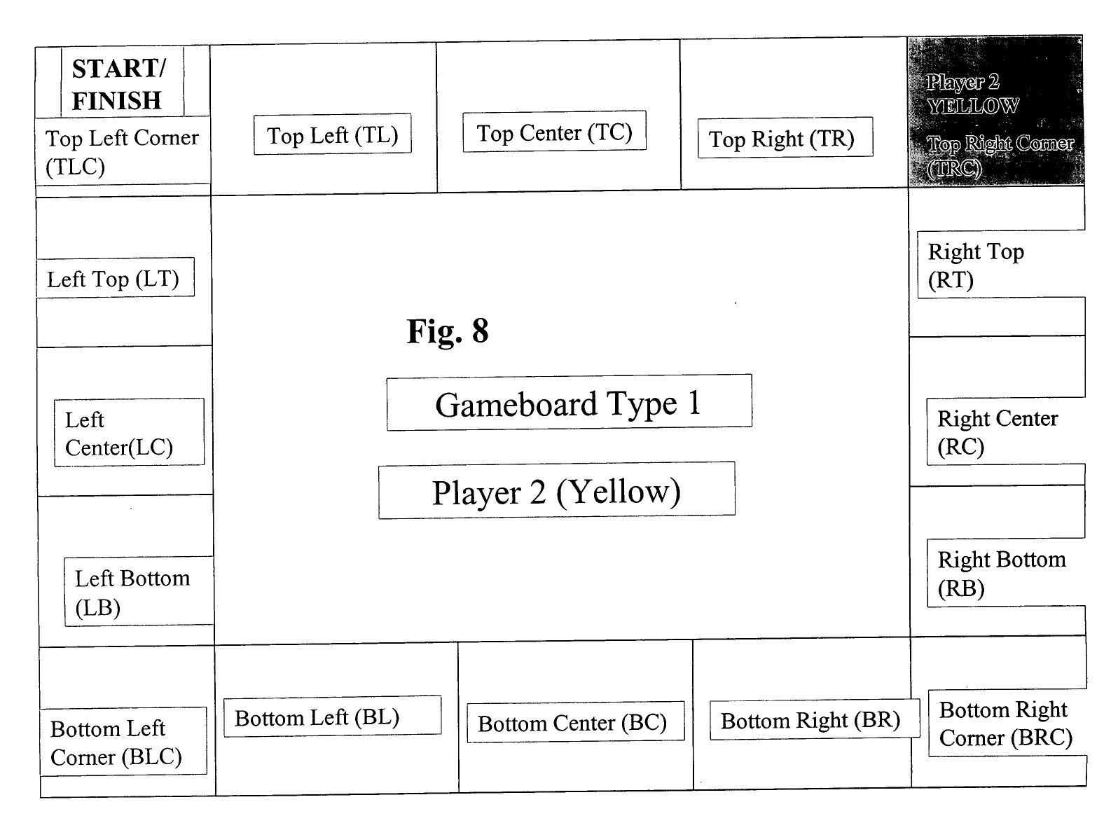

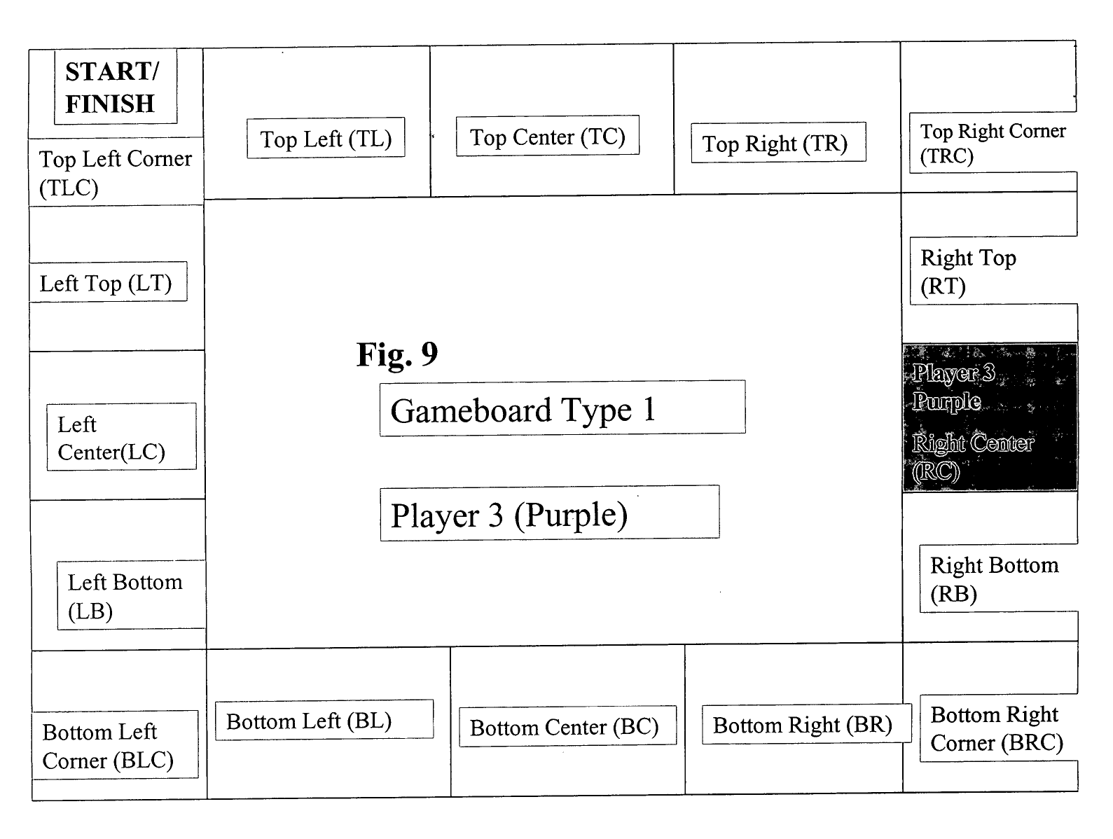

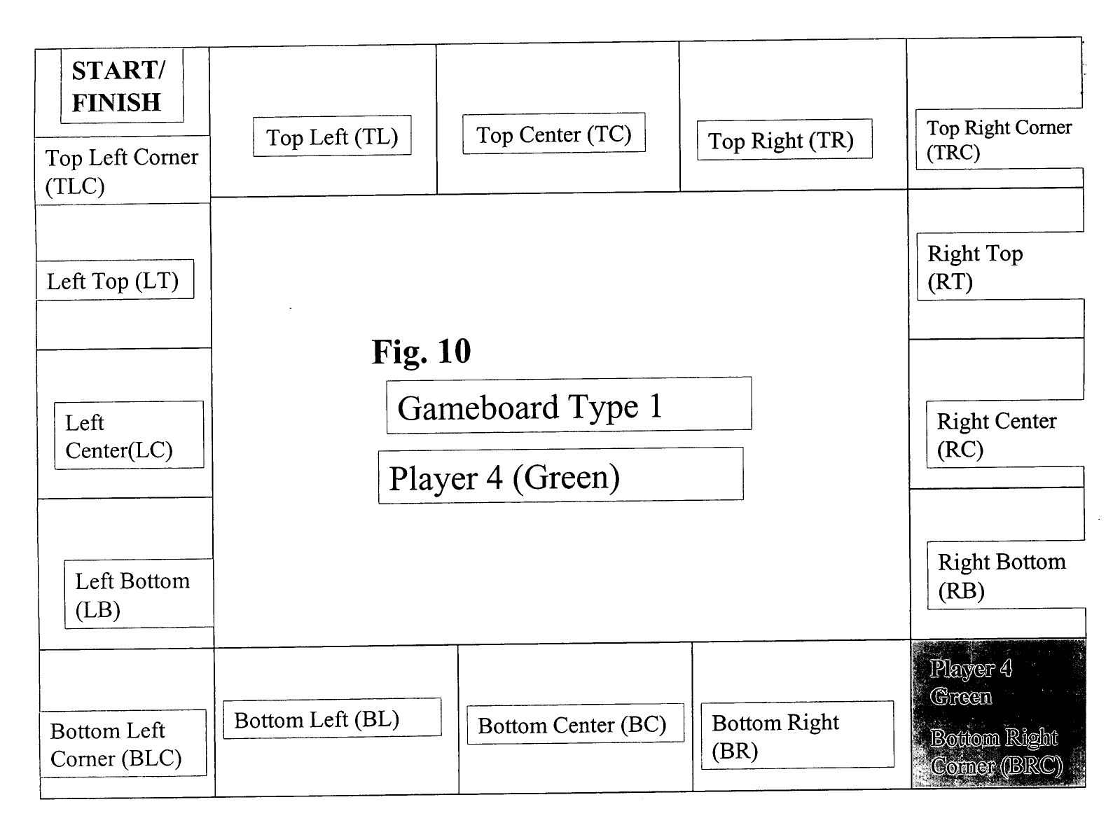

FIGS. 7, 8, 9 and 10 show how each of four players are displayed on the board segments, by position as well as color. Of course, a symbol such as a car or character could be used to represent the particular player on the board. Again, this would simply be a display of a particular video clip, selected by the game program manager, during each players' respective turn.

As illustrated, each game player has a representative indicator located in a particular segment, corresponding to the players progress through the game, i.e., around the game board. Each segment is linked to an aspect of the game, for example to challenge the player such that the player may advance, retreat, or stay on the segment. Landing on the segment triggers a generation of the aspect of the game, such as soliciting input from the player or automatically transferring the player to a new segment for continued game play.

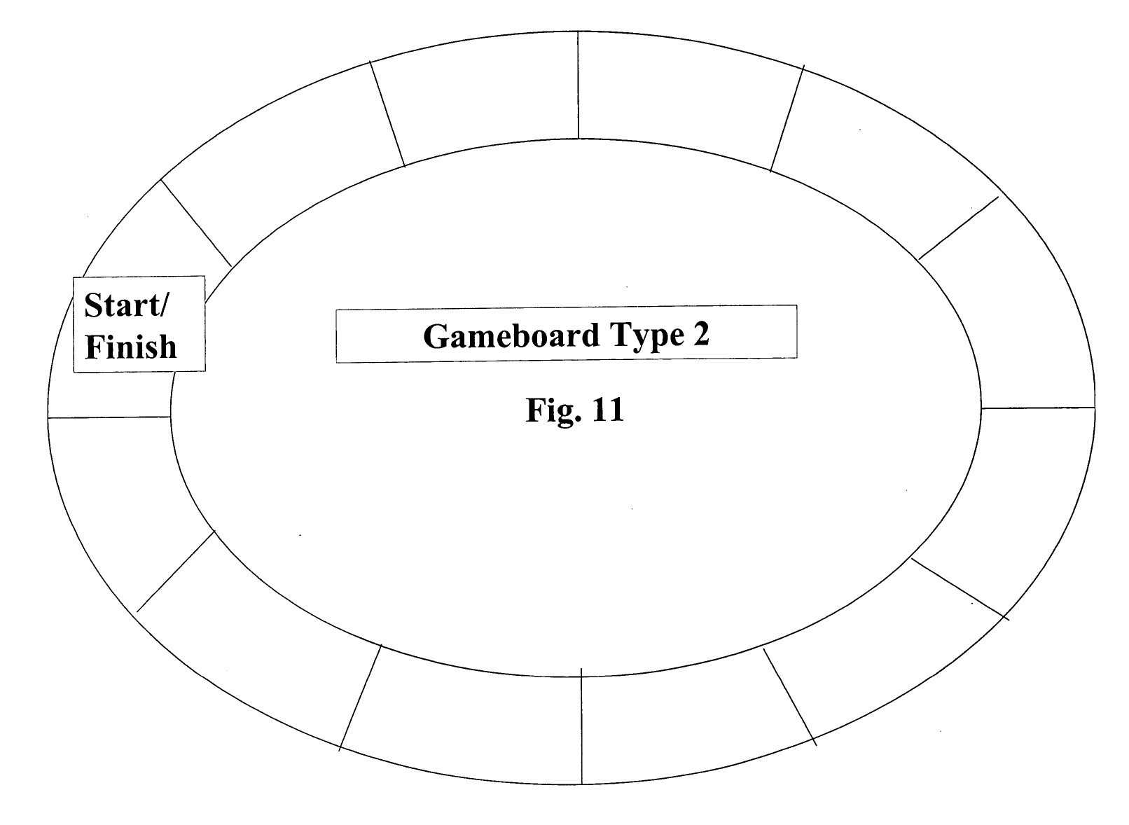

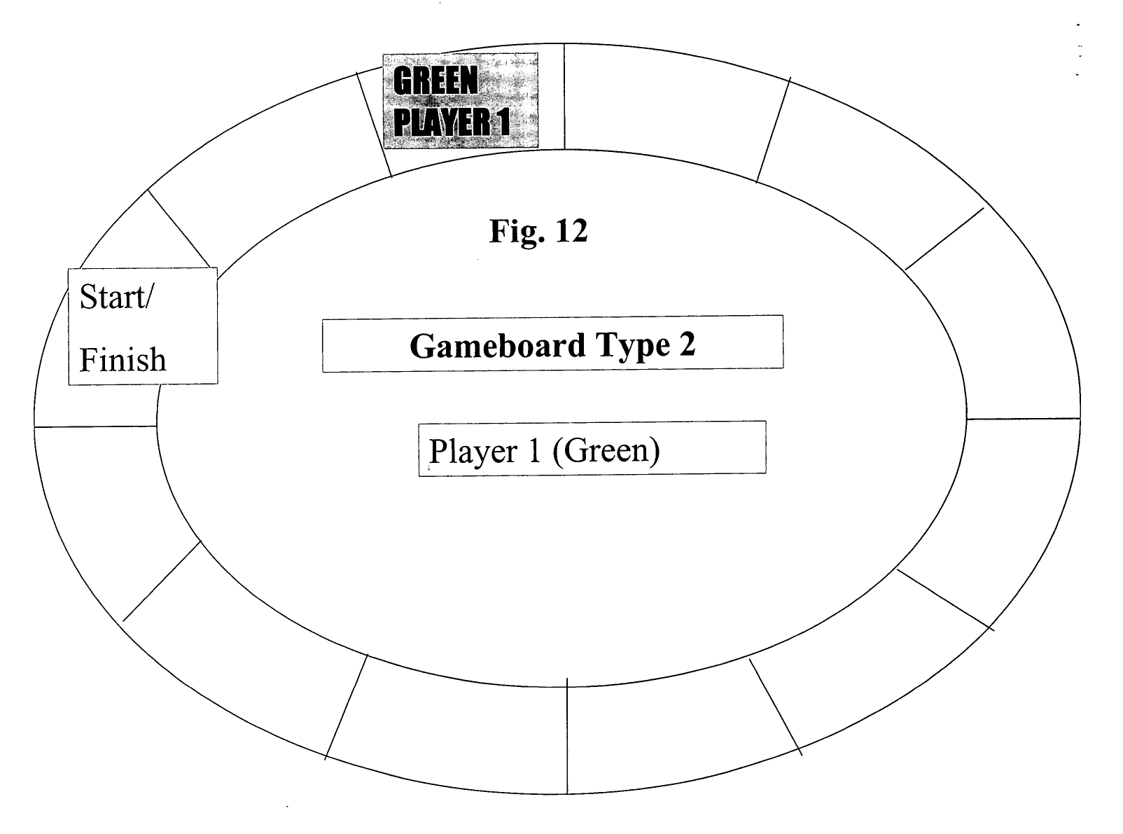

FIGS. 11 and 12 illustrate another game board embodiment, this one being oval shaped, FIG. 11 being the game board itself, and FIG. 12 illustrating a player on the game board.

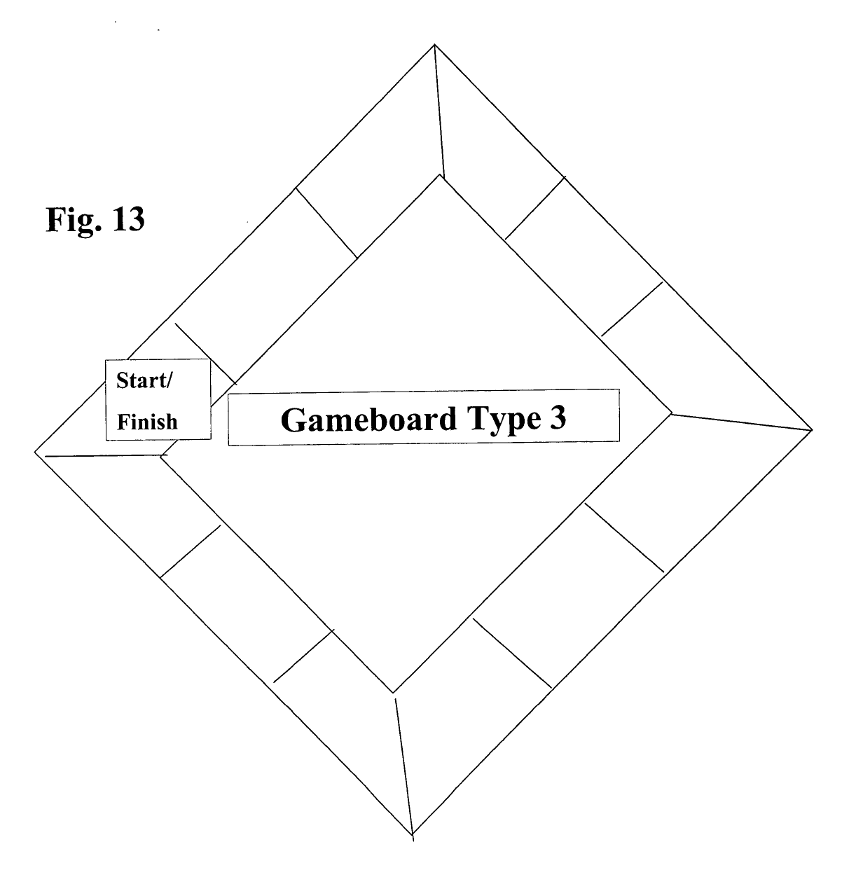

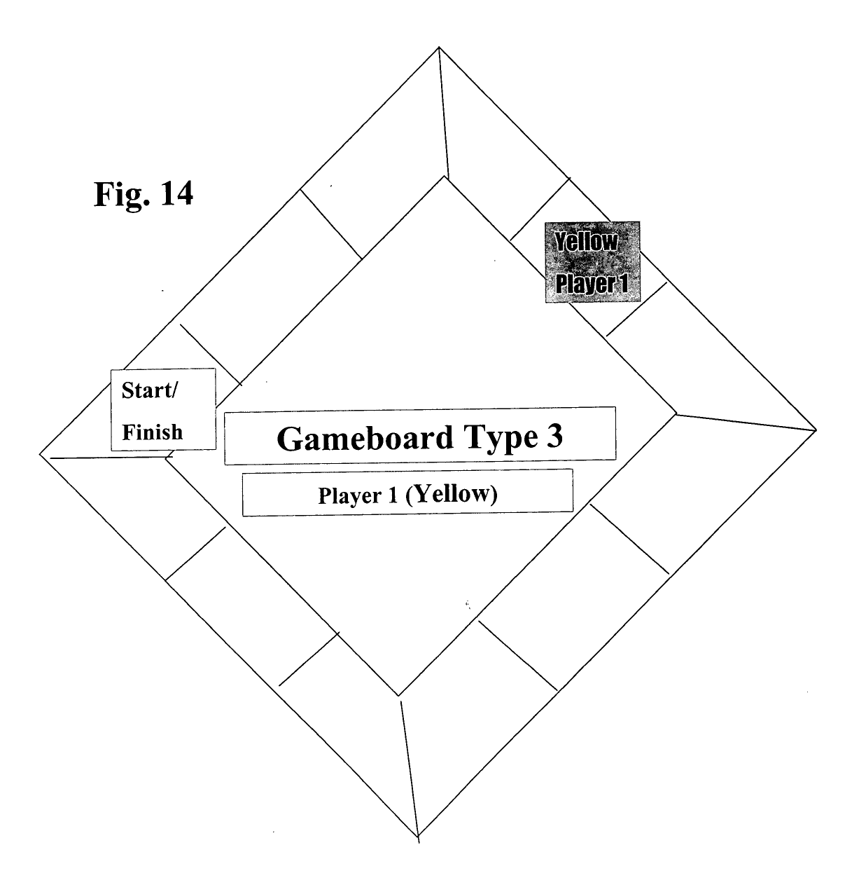

FIGS. 13 and 14 illustrate another game board embodiment, this one being diamond shaped, FIG. 13 being the game board itself, and FIG. 14 illustrating a player on the game board.

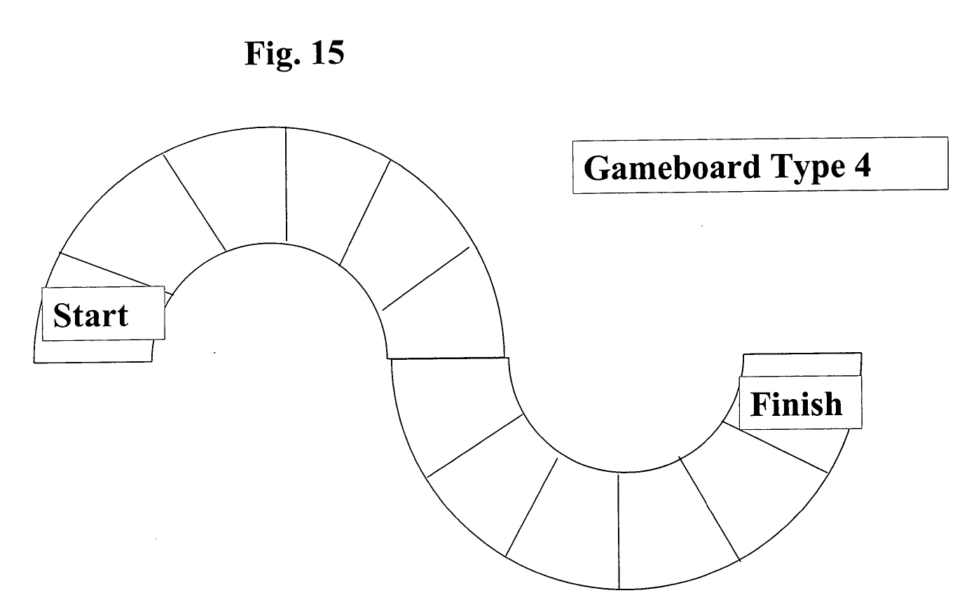

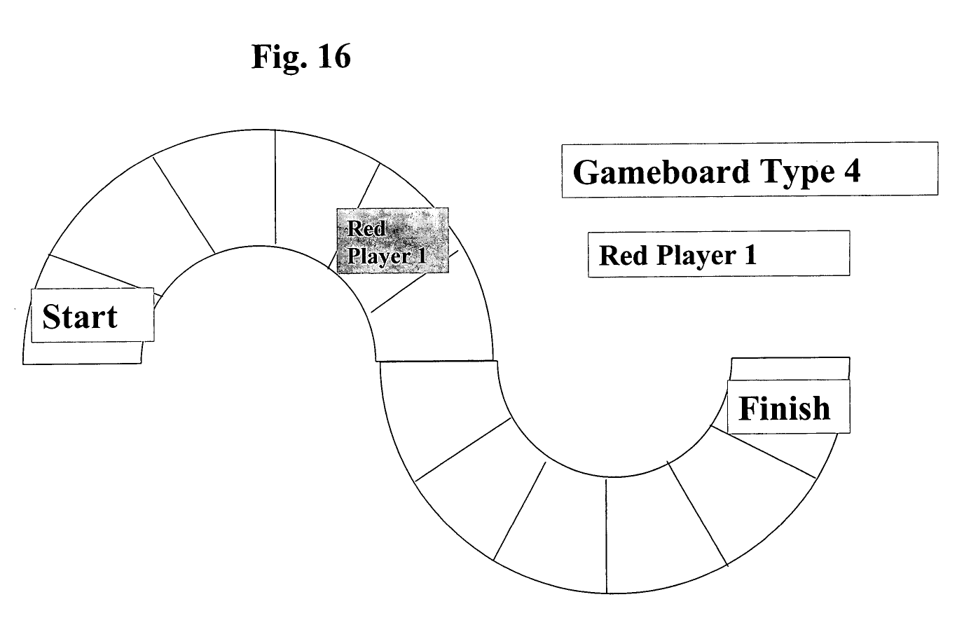

FIGS. 15 and 16 illustrate another game board embodiment, this one being serpentine shaped, FIG. 15 being the game board itself, and FIG. 16 illustrating a player on the game board.

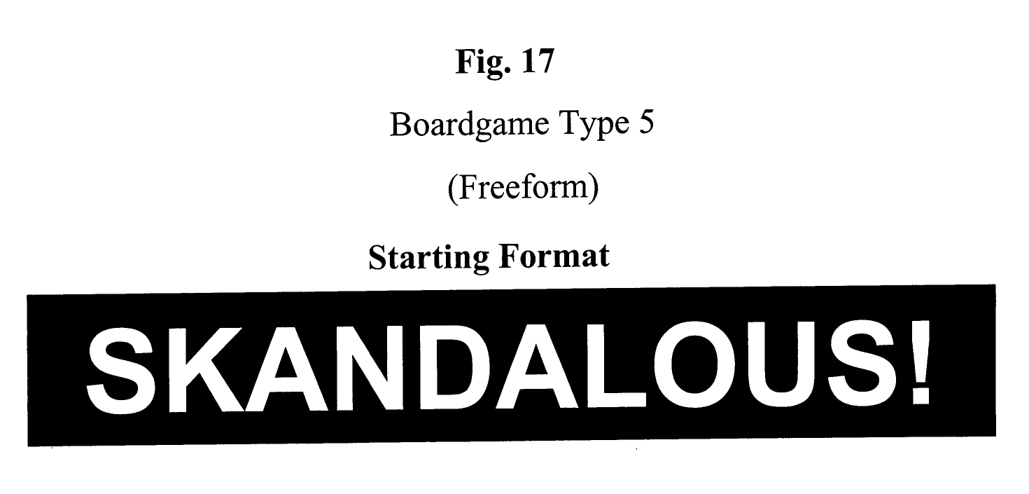

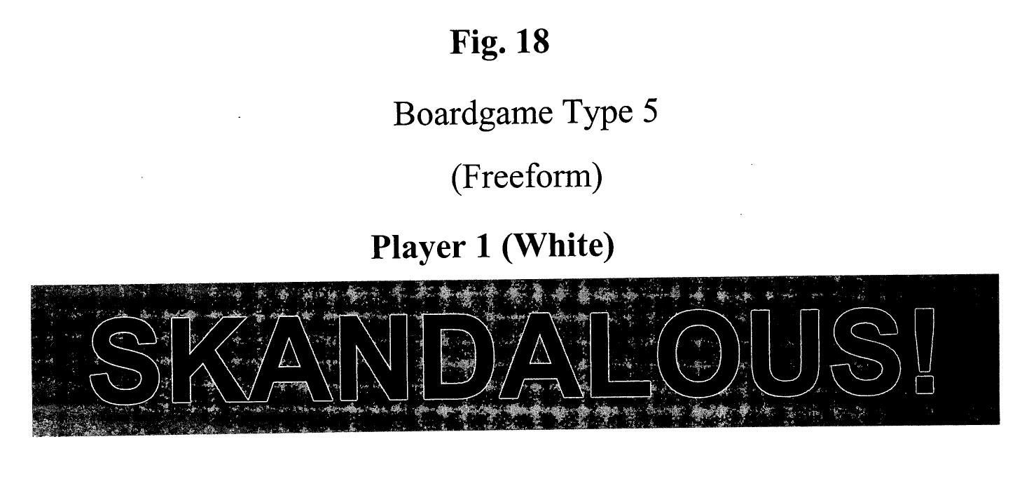

FIGS. 17 and 18 illustrate another game board embodiment, this one being fillable text. The text is shown against a contrasting background. This allows filling the letters with various colors, each color representing a particular player. For example, FIG. 18 illustrates a player who has white as his color, and he has moved through the first four letters of the game board. The other players may be red, yellow, or green, for example, their positions shown in the same way.

Using the present invention, multiple players work their way around a game board featured as a border, which may take the form of a path, a word or be shaped in many different configurations, provided on the display. Each player observes their progress and can easily determine the progress of the other players.

In particular, the initial set-up of each game allows 2, 3 or more players to play the game together by passing the controller between players to interface with the game on their turn, similar to passing a pair of dice. Winning is determined by the first player to achieve a predetermined winning region on the displayed board. The inventive system provides a real board game feel to the game play, while still using only a conventional DVD player of limited processing capability and memory.

In a preferred embodiment, each segment is randomly or pre-selectively linked to specific content contained on the DVD, such as specific video and/or audio clips that are displayed when activated by a player entering that segment. The player would reach the segment based on a random number generator which instructs on how many spaces to move. The user advances, for example, 3 spaces or segments in response to a simulated dice roll, from a start position. Reaching the segment triggers another random or pre-selected activity, for example, a video clip is played and the player engaged and directed to enter a response. For example, a video clip is played and the user directed to answer a question, his response entered using the DVD player remote control device. The response is determined to be correct or incorrect, and if correct, the player may advance, receive a bonus, or simply be allowed to stay in the space, etc. Many options are available, that is, all options common to board games in general can be integrated into the inventive system.

Thereafter, the next player may take a turn, and game play continues accordingly, with the players receiving visual feedback from the game board display as to their progress relative to each other so as to keep all the players engaged.

Throughout game play, the game board is displayed before each player turn to give positional information and the progress of the player after their turn is completed. The entire game can be played on a conventional DVD player having no more than the typical 8 GPRM's.

The DVD allows user input to simulate a board game using video and audio content and storing the player scores and interactions on the GPRM's. The GPRM, for example, would be given a random value and based on this value, a video would play of dice being rolled, or a wheel spun, and then the number would be displayed. The representative image of the player would then virtually move the prescribed number of segments across the game board. The DVD would contain a number of video clips equal to the number of possible random number assigned to the GPRM to maximize the ability to play the game a number of times without significant repetition. Additionally, there would have to be a number of movies at least equal to the number of segments or spaces so as to avoid duplication or discrepancies to the player.

After a players' turn, the position of their representative image on the board would be stored. Other information could also be stored such as state (lose turn), value (money accumulated, or score achieved), etc, unique to the player. The next player then takes a turn. The number of players may vary depending on the game, but usually will be no more than 6.

Logic is used to store more than one value in a GPRM using AND/OR functionality to access smaller portions of a GPRM. Using such logic can increase the data bit storage for example from 8 bits to 16 bits, effectively giving a game programmer more ability to support the interactive game play.

In the case of a DVD board game, the programmer has the ability to store character data in the first four bits, board location in bits 5-12, and score in bits 13-16, for a four player game.

Of course, the number of bits and assignment could be dynamic depending on what the programmer needs. For example, using the AND command the programmer could access the first 4 bits by telling the player to take the “GPRM AND 15”. This would create a mask of 0000000000001111 and any bits stored in the GPRM that are 1 where the mask is also 1 would return a 1, thereby effectively ignoring all other bits in the GPRM. Functionally, the same applies to the other logical data chunks in the GPRM, that is, to access bit 5-12 would require a mask of 4080 or 0000111111110000 and to access the final 4 bits would require a mask of 61440 or 1111000000000000.

Consequently, the invention provides a non-numeric approach for tracking game play progress in an interactive game environment as an alternative to numeric scoring, the game employing a media player, such as a DVD player, using programming on the DVD game disk to manage game play, deliver questions or game challenges to each player, determine if a player is right or wrong, keep track of the progress of each player and display the player's progress on a game board displayed on the screen, without the need to show actual numerical scoring as a method to keep track of the progress. There are no other separate parts or game board required to play the game, and everything required to play the game is contained within the media disc for the game.

The media disc provides the following as an integrated part of the game:

A game board is shown on the video screen

Automatically manages the game play and randomizes play

Randomly selects questions and mini-games to present to each player

Keeps track of whose turn it is

Keeps track of the progress of each player

Shows where each player is on the game board

Knows when the game is over

Knows who won/lost and when.

The key is the flow control established by navigating the DVD according to GPRM settings which allows keeping track of the game board state on the DVD, using the limited number of GPRMs typically available in a DVD player. The following is an exemplary code sample illustrating process for utilizing the bits in a GPRM. The GPRM is split into 4 equal 4 bit sections allowing for each section to store a number between 0 and 15 inclusive.

DVD GPRM Code Sample

```
Pre Command=List
{
    #Clear GPRM0
    Item=Command
    {
        Name=blank-t-pgc_cmd_1
        Command=Mov GPRM0, 0
    }
    #Fill the first 4 bits of GPRM0 with 1111
    #This can be any number that is a multiple of 1 between 0 and 15
    Item=Command
    {
        Name=blank-t-pgc_cmd_2
        Command=Add GPRM0, 15
    }
    #Fill the second 4 bits of GPRM0 with 1111
    #This can be any number that is a multiple of 16 between 16 and 240
    Item=Command
    {
        Name=blank-t-pgc_cmd_3
        Command=Add GPRM0, 240
    }
    #Fill the third 4 bits of GPRM0 with 1111
    #This can be any number that is a multiple of 256 between 256
    and 3840
    Item=Command
    {
        Name=blank-t-pgc_cmd_4
        Command=Add GPRM0, 3840
    }
    #Fill the fourth 4 bits of GPRM0 with 1111
    #This can be any number that is a multiple of 4096 between 4096
    and 61440
    Item=Command
    {
        Name=blank-t-pgc_cmd_5
        Command=Add GPRM0, 61440
    }
    #copy the data from GPRM0 to another GPRM to retain integrity of
    #GPRM0 while manipulating data
    Item=Command
    {
        Name=blank-t-pgc_cmd_6
        Command=Mov GPRM1, GPRM0
    }
    #Use the And command to mask out the unused data from the GPRM
    #leaving only the first 4 bits containing the original data stored
    #in the first 4 bits of GPRM0
    Item=Command
    {
        Name=blank-t-pgc_cmd_7
        Command=And GPRM1, 15
    }
    #copy the data from GPRM0 to another GPRM to retain integrity of
    #GPRM0 while manipulating data
    Item=Command
    {
        Name=blank-t-pgc_cmd_8
        Command=Mov GPRM2, GPRM0
    }
    #Use the And command to mask out the unused data from the GPRM
    #leaving only the second 4 bits containing the original data stored
    #in the second 4 bits of GPRM0
    Item=Command
    {
        Name=blank-t-pgc_cmd_9
        Command=And GPRM2, 240
    }
    #copy the data from GPRM0 to another GPRM to retain integrity of
    #GPRM0 while manipulating data
    Item=Command
    {
        Name=blank-t-pgc_cmd_10
        Command=Mov GPRM3, GPRM0
    }
    #Use the And command to mask out the unused data from the GPRM
    #leaving only the third 4 bits containing the original data stored
    #in the third 4 bits of GPRM0
    Item=Command
    {
        Name=blank-t-pgc_cmd_11
        Command=And GPRM3, 3840
    }
    #copy the data from GPRM0 to another GPRM to retain integrity of
    #GPRM0 while manipulating data
    Item=Command
    {
        Name=blank-t-pgc_cmd_12
        Command=Mov GPRM4, GPRM0
    }
    #Use the And command to mask out the unused data from the GPRM
    #leaving only the fourth 4 bits containing the original data stored
    #in the fourth 4 bits of GPRM0
    Item=Command
    {
        Name=blank-t-pgc_cmd_1_1
        Command=And GPRM4, 61440
    }
```

While various embodiments of the present invention have been shown and described, it will be understood by those skilled in that art that various changes and modifications can be made without varying from the spirit and scope of the invention, and the foregoing description is intended to describe the preferred embodiments of the present invention but not to limit the invention in any way.

What is claimed is:

1. An interactive multi player DVD gaming system comprising a DVD containing game data and a game manager program for playing an interactive DVD board game on a display, a DVD media player configured for accessing and displaying the game data on the DVD in response to receiving user selected inputs, at least one user operated control for generating the user selected inputs sent to the DVD media player, the DVD media player having multiple general parameter register memories (GPRM's), the game program manager configured to direct the GPRM's for supporting multiplayer game play with display of a virtual game board.

2. The DVD gaming system of claim 1 wherein the game program manager has program instructions for using one or more GPRM's for generating a random number for supporting game play.

3. The DVD gaming system of claim 2 further comprising means for displaying the random number as a single dice roll, a double dice roll or as a wheel spin.

4. The DVD gaming system of claim 1 wherein the user operated control is a remote control.

5. The DVD gaming system of claim 1 wherein the user operated control is a game controller adapted for use with the DVD media player and having specific functions corresponding to game configured inputs.

6. The DVD gaming system of claim 1 wherein the game data readable by the DVD media player displays on a monitor a border region having discrete segments simulating a typical game board where a player moves from space to space, the game program manager controlling the display of game progress and game play.

7. The DVD gaming system of claim 6 wherein the game program manager provides each game player with a representative indicator located in a particular segment, corresponding to the players progress through the game, the indicator selected from the group consisting of a symbol, color, icon, text or a combination thereof

8. The DVD gaming system of claim 6, wherein each segment is linked to an aspect of the game.

9. The DVD gaming system of claim 8 wherein the game aspect is selected from the group consisting of a challenge to a player, a question, an automatic displacement, and combinations thereof whereby the player may advance, retreat, or stay on the segment, and landing on the segment triggers a generation of the aspect of the game, such as soliciting input from the player or automatically transferring the player to a new segment for continued game play.

10. The DVD gaming system of claim 2 wherein the random number generated in response to a user input is used for determining each players' moves.

11. The DVD gaming system of claim 1 wherein the game program manager uses logic to store more than one value in a GPRM using AND/OR functionality to access smaller portions of a GPRM, to increase the data bit storage for supporting interactive game play.

12. The DVD gaming system of claim 11 wherein the game program manager uses logic for configuring one or more GPRM's to generate a random number in response to a user input.

13. A method for providing a segmented game board for display when playing a DVD game comprising providing a game control manager on a DVD, using the game control manager to configure GPRM's on the DVD to allow user input to simulate a board game using video and audio content stored on the DVD, and storing the player scores and interactions on the GPRM's to track game play.

14. The method of claim 13 further comprising generating a random number in response to a user input, displaying the random number to the user and moving a player around the board game the displayed number of spaces.

15. The method of claim 14 wherein the random number is displayed as one or more dice faces, or as a number indicated on a wheel.

16. The method of claim 13 further comprising storing more than one value in a GPRM using AND/OR functionality to access smaller portions of a GPRM, to increase the data bit storage for supporting interactive game play.

17. The method of claim 13 further comprising generating a random number in response to user input.

18. The method of claim 13 further comprising using logic for configuring one or more GPRM's to generate a random number in response to a user input.
